(19) United States
(12) Patent Application Publication
(10) Pub. No.: US 2008/0276512 A1
(43) Pub. Date: Nov. 13, 2008

(54) Shelving label holder

(76) Inventor: Mitra Jafari, Anaheim, CA (US)

Correspondence Address: Mitra Jafari, 7549 E. Bridgewood Dr., Anaheim, CA, 92808, US

(21) Appl. No.: 11/803,137

(22) Filed: May 8, 2007

(51) Int. Cl. G09F 3/18

(52) U.S. Cl. 40/642.02

(57) ABSTRACT

A label holder for shelving units which consists of a front and back plate designed to fit within the shelving face so as to not interfere with the removal of objects from the said shelving unit. The front plate comprises of an aperture to receive label inserts and a threaded stud attached by some means to the back of the front plate. This said threaded stud is designed to be drawn through the opening of the shelving face and received through a central hole of the back plate. The above mentioned plates are mounted on the shelving face by a fastener, e.g. a nut, fastened by rotation on the threaded stud so as to hold the plates in place.

### BACKGROUND OF THE INVENTION

The present invention is directed to label holders for mounting on channels or shelves of wire shelving units, or other types of shelves. In particular, the invention is directed to an improved label holder which can be mounted upon shelf channels of various configurations and sit inside the shelving face.

Similar label holders for said shelving units were initially designed consisting of a plastic piece where the front wall has protruding openings pointing outward that snap on under a projecting portion of the shelving face. This held the advantage of an easy to make, easy to use labeling method.

The above mentioned label holder had a significant disadvantage. When inserting or removing heavy commodities from the shelving units, the plastic holders would snap off or break from the pressure of the commodities being stored.

### SUMMARY OF THE INVENTION

It is an object of the invention to remove or reduce the drawbacks of the prior art holders for shelving unit label holders and to provide an improved holder of this kind.

It is a special object of the invention to provide an improved label holder for said shelving units that can sit within the shelving face, eliminating the chance of breakage or loss.

A further object of the invention is to provide an improved label holder for said shelving units which is durable and long-lasting.

These objects and advantages of the invention, which also will appear from the following description, are achieved while maintaining the advantages of the prior art holders.

The present invention provides an improved form of label holder mountable on said shelves. The label holder is comprised from any resilient material and consists of a front plate fitted to the size of the shelving face with a threaded stud attached by some means to the back side of the front plate and an aperture on the top or either side of the front plate wherein a label and a plastic protection fit within the aperture. The front plate is joined by a back plate fitted to the front plate with a hole in the back center to receive the threaded stud and fixed firmly by a fastener, e.g. a nut.

To mount the label holder on the shelving unit, the front plate with attached piece mentioned above is drawn thru the shelving face and joined from the back of the shelving face with the back plate. The fastener is then fixed firmly into the threaded stud from the back side of the shelving face, clasping the label holder in place.

Thus, the label holder of the present invention provides an improved means for mounting labels on shelving units. The label holder accommodates shelf channels of various configurations and can be removed and/or shifted across the shelving face by simply unfastening the fastener and reaffixing as desired.

### BRIEF DESCRIPTION OF THE DRAWING

For a complete understanding of the above and other features of the invention, reference shall be made to the following detailed description of the preferred embodiments of the invention and to the accompanying drawings, wherein:

FIG. 1 is a diagonal view of the invention with parts broken away so as to distinguish between them and how they fit together.

FIG. 2 is a view of FIG. 1 with the inclusion of an aperture on the left or right side of the front plate and exclusion of the top aperture on the front plate in FIG. 1.

FIG. 3 is a view of FIG. 2 with the front plate not being parallel to the shelving face.

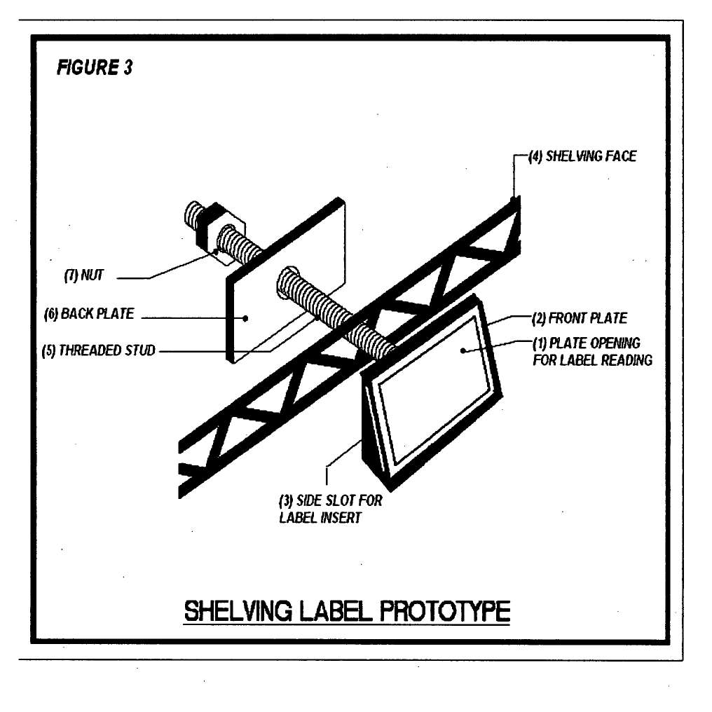

### DESCRIPTION OF THE PREFERRED EMBODIMENT

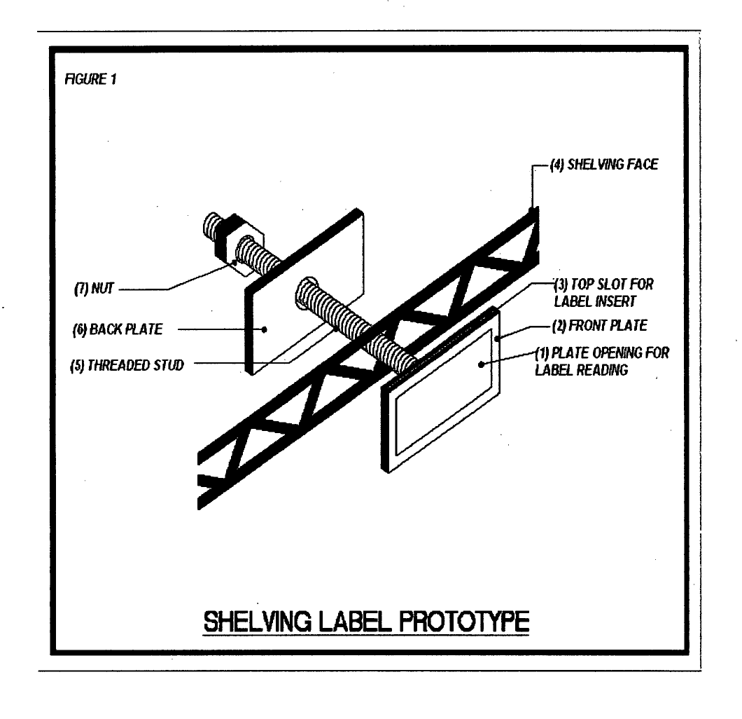

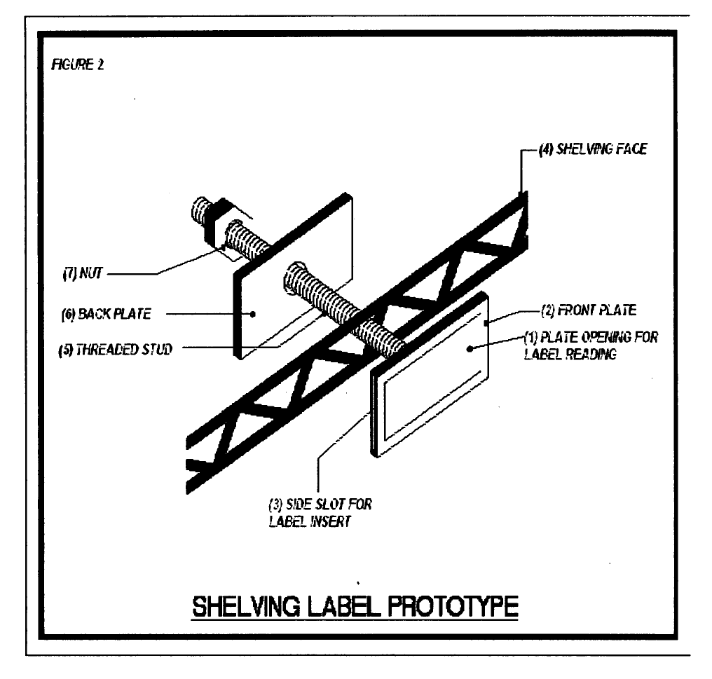

Referring to FIG. 1-2, the label holder comprises of a front plate designated at 2 and back plate of the same size at 6, the front plate, 2, includes a plate opening for label reading at 1 and either a top aperture for label insert as shown by 3 in FIG. 1 or side aperture for label insert at 8 designated in FIG. 2.

The front plate, 2, also comprises of a threaded stud designated at 5, attached by some means to the back center of the front plate 2.

The back plate, 6, also comprises of a central hole designed to receive the threaded metal, 5 once inserted through an opening on the shelving face at 4.

The front plate, 2, and back plate, 6, are mounted on the shelving face, 4, with 4 resting in between both 2 and 6. The front and back plates, 2 and 6, are secured by the fastener, 7, e.g. a nut when fastened by rotation on the threaded stud, 5.

What is claimed is:

1. A label holder comprising:
any resilient material and consists of a front plate that is fitted to the size of the shelving face with a threaded stud attached to it's back side; wherein a back plate fitted to the front plate with a hole in the back center to receive the threaded stud and fixed firmly by a fastener, e.g. a nut.

2. The label holder according to claim 1, wherein the threaded stud is attached by some means to the back side of the front plate, is drawn through an opening in the shelving face and received from the hole in the back plate and is fixed by a fastener, e.g. a nut.

3. The label holder according to claim 1, wherein the front plate consists of an aperture either at the top or on either sides of the plate; wherein a label and a plastic protection fit with in the aperture.

4. The label holder according to claim 1, wherein the front plate has a threaded stud attached it's back side.

5. The label holder according to claim 1, wherein the front plate comprises of a rectangular opening so to see the label with in it.

6. The label holder according to claim 1, wherein the width of the front plate is enough so as to fit a label and a plastic cover with in the aperture of the front plate.

7. The label holder according to claim 1, wherein the back plate fitted the front plate, includes a hole in the back center to receive the threaded stud that is attached to the front plate.

8. The label holder according to claim 1, wherein the front plate and the back plate are designed to fit with in the shelving face so as not to interfere with the removal of articles from the said shelving unit for articles.

9. The label holder according to claim 1, wherein the front plate is not parallel to the shelving face.
